(19) United States
(12) Patent Application Publication
(10) Pub. No.: US 2007/0240328 A1
(43) Pub. Date: Oct. 18, 2007

(54) Continuous air flow dehydrator and method for improved energy efficiency

(76) Inventor: Mike Moles, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/406,111

(22) Filed: Apr. 18, 2006

(51) Int. Cl. F26B 25/06; F26B 19/00

(52) U.S. Cl. 34/218; 34/227

(57) ABSTRACT

A dehydrator for improving energy efficiency and reducing the cost and air pollution associated with drying food products, such as grapes into raisins. The improved dehydrator utilizes the same basic structure as prior art dehydrators, which have multiple drying tunnels that each define a drying chamber in which the products are dried and a burn chamber in which a heat source heats air that is circulated to the drying chamber by a circulating fan. To reduce fuel consumption, the dehydrator of the present invention closes the openings into the tunnel, whereas currently only a front opening is closed, and utilizes a recirculating fan to draw heated air from the drying chamber for re-heating, at lower cost, by the heat source. A filter is used to remove moisture and contaminants from the recycled air and a diversion hood is used to direct the recycled air from direct contact with the heat source.

### CROSS-REFERENCE TO RELATED APPLICATIONS

None.

### BACKGROUND OF THE INVENTION

A. Field of the Invention

The field of the present invention relates generally to apparatuses and methods for drying agricultural food products in dehydrating tunnels having forced-air dryer systems. More particularly, the present invention relates to such agricultural dehydrating systems that utilize one or more heaters to heat air which is forced through the dehydrating tunnel to dry fruit or other agricultural products contained on moveable trays and the like.

B. Background

Various agricultural food products are processed by drying the raw product to obtain its dried counterpart. Examples of agricultural food products which are commonly dried to obtain a second commercial food product are the drying of grapes into raisins and plums into prunes. As well known by those in the agricultural industry, raw fruits or other raw agricultural products are subjected to a heat source that removes a desired amount of moisture from the raw product until it has reached its desired “dry” condition. Originally, most drying of food products took place outdoors with the sun as the source of heat, as exemplified by the drying of grapes on paper trays laid out on the ground between the rows of grapevines to obtain raisins. While the drying of grapes or other agricultural products in the sun is an energy efficient method of removing the moisture from the raw products, it is neither a reliable nor a time efficient manner of obtaining the dried fruit. For instance, the laying out of the food products in the sun always subjects the food products to the risk of rain which, in addition to not providing the desired heat to dry the products, can cause mold or other problems that reduce the quality and quantity of saleable product. Even without rain, the amount of heat available for drying the food products in the sun is not able to be regulated, resulting in an unknown and uncontrollable amount of time being required to dry the raw product into the dried product.

To address the issues regarding sun drying of raw agricultural food products into their affiliated dried product, the use of oven-type drying systems were initiated to dry, wholly or partially, the raw product into the dried product. Various types of drying systems are in use. For purposes of commercial or large scale drying of food products, such systems typically comprise a drier having a drying chamber that receives large quantities of the raw or partially dried food products therein, where the food products are subjected to heat until they are dried into the desired dried product having the desired moisture content. A heater or like device provides the heat for drying the food products. As well known to those in the food processing industry, the drying of food products in this manner consumes relatively large amounts of fuel, typically natural gas, propane or the like, and the application of the heat must be carefully controlled to avoid damaging the fruit due to excessive temperatures. One commonly used process to avoid heat damage from the direct application of heat to the food products is the use of a heated, forced air circulation system that passes dry, hot air over or through the food products to dry them.

A common drying system that is utilized for the processing of grapes and plums into raisins or prunes is an air flow dehydrator that comprises a relatively long, linear two-level tunnel structure that has a drying chamber in the lower level and a heated forced-air system in the upper level, which defines a burn chamber therein. Typically, a dehydrating facility will have as few as four and as many as seventy-five such tunnels that are joined side-by-side, but closed off from each other. Except for air flow openings at the front and near the rear of the tunnel, the upper level is substantially separated from the lower level by a intermediate floor. The grapes or plums are placed on trays or similar containers that are stacked together and moved inside the drying chamber on a trolley, conveyor or other tray moving apparatus, through the open backside of the lower level. The heat source is typically positioned near the rear of the burn chamber, where it receives air through one or more openings in the back of the upper level. The typical heat sources is a propane fueled flame that extends into the burn chamber. A circulating fan draws the heat from the heat source and forces the heated air towards the closed front end of the tunnel's upper level, where the heated air travels from the upper level to the lower level, the front of which is also closed (by doors), to flow between the stacked trays in the drying chamber to dry the grapes or plums on the trays. The use of forced, heated air improves the speed and consistency of the drying and substantially reduces the likelihood of food burn damage. After passing over or through the fruit, most of the heated air exits out the open back of the tunnel and is discharged to the atmosphere to allow the moisture-rich air to exit the tunnel. A small portion of the heated air circulates back to the burn chamber in the second level where it joins fresh air drawn in through the second level openings. Once the fruit is sufficiently dried, the front doors are opened and the trays are moved out of the drying chamber through the open doors.

One of the major disadvantages associated with the presently available air flow dehydrators and their method of use is the amount of energy that is consumed, typically in the form of propane or other flammable gas, to provide the heated air. It is not unusual for a dehydrating facility having thirty tunnels to consume several thousand gallons of fuel during the three to four month period when the facilities are used to dry grapes or plums. Larger facilities will use much more fuel. The large consumption of fuel is primarily due to the loss of heated air through the open backside of the lower level and the heating of the ambient air that is being drawn into the burn chamber for circulation to the food products. Another disadvantage associated with the configuration and method of use of current dehydrating facilities is that the discharged air is known to contain pollutants, particularly hydrocarbons, that are harmful to the air quality of the atmosphere. In addition, certain types of processing operations contribute other pollutants to the discharged air. For instance, some grapes are processed into golden raisins by the addition of sulphur, which results in the golden color, to the heating process. Unfortunately, this use is known to raise environmental concerns that may be regulated by governmental agencies.

What is needed, therefore, is an improved air flow dehydrator and method of use for dehydrating raw agricultural food products into their dried food product counterpart that reduces the consumption of fuel and the discharge of pollutants to the atmosphere. Preferably, the improved dehydrator and method will substantially reduce the amount of fuel utilized by the heater so as to reduce the cost of drying the raw food product, such as grapes and plums, into the dried food product, such as raisins and prunes. The preferred air flow dehydrator and method will utilize the same configuration as the existing tunnel-type dehydrators and be adaptable to retrofitting existing dehydrating facilities without a substantial cost or time (shut-down) investment. The preferred air flow dehydrator and method should reduce the discharge of pollutants to the atmosphere so as to reduce the impact of operating such facilities on the environment.

### SUMMARY OF THE INVENTION

The continuous air flow dehydrator and method for improved energy efficiency of the present invention solves the problems and provides the benefits identified above. That is to say, the present invention discloses a new and improved air flow dehydrator and method of operation that substantially reduces the amount of fuel consumed to heat the circulating air that is used to dry raw agricultural food products, such as grapes and plums, into dried fruit products, such as raisins and prunes, respectively. The continuous air flow dehydrator of the present invention reduces the amount of fuel consumed by the heater by; recirculating substantially all of the warm air back to the heater instead of drawing in ambient air to the heater and discharging the heated air out the drying chamber, thereby maximizing the efficient use of the fuel and heat. The preferred embodiment of the continuous air flow dehydrator closes the openings in the lower and upper levels of the tunnel structure and utilizes a recirculating fan to draw the air into the burn chamber, a diversion hood to direct the diverted air towards the circulating fan and a filter or filtering system to clean and remove moisture from the recirculated air. As such, the principles and method of the continuous air flow dehydrator of the present invention can be incorporated as a retrofit into existing tunnel air flow dehydrators with relatively low cost and low facility downtime. In addition to the cost savings that can be achieved by use of the present invention, the continuous air flow dehydrator will substantially reduce the amount of pollutants that are discharged to the atmosphere, which is likely to reduce or eliminate the need for governmental air regulations on such facilities. Use of the continuous air flow dehydrator and method of the present invention will substantially reduce the cost of processing raw food products, such as grapes and plums, into dried food products, such as raisins and prunes.

In one general aspect of the present invention, the continuous air flow dehydrator and method for improved energy efficiency comprises the same basic dehydrator structure utilized by prior art dehydrators except modified to improve the energy use efficiency of the hot air circulating system used to dry raw food products into dried food products. Existing dehydrator structures have a plurality of tunnels that each have an upper level defining a burn chamber and a lower level defining a drying chamber. The tunnels have large, generally full width openings into the drying chamber at the front/first end of the tunnel and at the opposite rear/second end of the tunnel for ingress and egress of a conveying mechanism, such as a trolley platform, that carries a stack of trays having the raw product thereon in and out of the drying chamber. The opening into the drying chamber at the first end of existing dehydrators has doors that are closed during drying operations. The opening at the second end has no doors and is left open to the atmosphere during drying operations. The drying chamber and the burn chamber are separated by a substantially horizontal dividing wall having an forward opening toward the first end of the tunnel and a rearward opening toward the second end of the tunnel. Disposed in the burn chamber is the heat source, typically a gas fueled flame, and a circulating fan to circulate the heated air to the drying chamber through the forward end of the dividing wall. The burn chamber has vent openings that open to the atmosphere, typically two such openings, to draw in ambient air for heating by the heat source.

The improvement of the present invention is to basically close the entire dehydrator system such that ambient air is not drawn into the burn chamber and heated air is not discharged out the drying chamber to reduce the amount of fuel necessary to heat the air to the desired temperature for drying the food products. In the dehydrator of the present invention, this is accomplished by providing one or more rear drying chamber doors at the rear opening, which directs the heated air back to the burn chamber instead of the atmosphere, and providing vent closing members to close the vents in the burn chamber to substantially prevent ambient air from entering therein. In a new facility, this can be achieved by the use of a wall at the second end of the tunnel that does not have the large rear opening or any vent openings or any other vent openings into the burn chamber. In a retrofit configuration, which is likely to be the most common use, this is achieved by adding doors to the second end, placing a solid panel over the vent opening at the second end of the tunnel and closing the trap door at the top wall of the tunnel. Although this alone may achieve some of the benefits of the present invention, in the preferred embodiment, a recirculating fan is placed in or at the rearward opening to draw the air from the drying chamber into the heat chamber and a filter is utilized at the rearward opening to remove any moisture and/or contaminants from the recycled air. In addition, the preferred embodiment includes a diversion hood to direct some or all of the recycled air away from contact with the heat source and towards the circulating fan. By reheating the heated air after it dries the food products, the dehydrator of the present invention reduces the amount of fuel necessary to raise it to the desired temperature, thereby saving significant amount of fuel costs. In addition, the dehydrator of the present invention substantially reduces the amount of air discharged to the atmosphere, thereby reducing air pollution.

Accordingly, the primary objective of the present invention is to provide a continuous air flow dehydrator and method for improved energy efficiency that provides the advantages discussed above and overcomes the disadvantages and limitations associated with presently available air flow dehydrators.

It is also an object of the present invention to provide a continuous air flow dehydrator for drying large quantities of raw agricultural food products into dried food products that substantially reduces the amount of energy required to heat the air used for drying and to reduce the amount of pollutants discharged to the atmosphere from such operations.

It is also an object of the present invention to provide a continuous air flow dehydrator that has a dual level, tunnel-shaped structure having a drying chamber and a burn chamber that recirculates air from the drying chamber, after being used to dry raw food products, to the burn chamber where it is reheated and then circulated back to the drying chamber, thereby reducing the amount of fuel consumption necessary to heat the air and dry the food products.

It is also an object of the present invention to provide a continuous air flow dehydrator and method of using the same that reduces the cost of drying large quantities of raw food products, such as grapes and plums, into dried food products, such as raisins and prunes, by reducing the amount of fuel consumed to heat the air circulated through stacked trays of such food products.

It is also an object of the present invention to provide a continuous air flow dehydrator and method of using the same that is suitable for retrofitting existing air flow dehydrators, such as those used in the raisin and prune drying industries, without substantial investment in cost and time to accomplish such retrofitting.

It is also an object of the present invention to provide a continuous air flow dehydrator and method of using the same that substantially closes the drying and burn chambers during operation and includes a secondary fan to direct the air used to dry the products to the burn chamber for reheating, a diversion hood to direct the recirculated air to the circulating fan and a filter to remove moisture and other contaminants from the recirculated air.

It is also an object of the present invention to provide a continuous air flow dehydrator and method of using the same that substantially reduces the amount of pollutants discharged to the atmosphere from operation of the dehydrator to dry raw food products into dried food products.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is front view of a prior art air flow dehydrator showing one set of front drying chamber doors in the open position;

FIG. 2 is a rear view of the prior art flow dehydrator of FIG. 1 showing the rear openings of the drying chambers with a stack of trays on a trolley in one drying chamber;

FIG. 3 is a cross-sectional side view of one of the tunnels of the prior art air flow dehydrator of FIG. 1 showing the movement of air in, through and out of the burn and drying chambers;

FIG. 4 is a cross-sectional side view of one of the tunnels in a dehydrating facility of a continuous air flow dehydrator configured according to a preferred embodiment of the present invention showing the improvements to existing air flow dehydrators; and

FIG. 5 is a rear view of a continuous air flow dehydrator configured according to a preferred embodiment of the present invention showing the burn chamber doors and rear drying chamber doors with one set of the rear drying chamber doors in a partially open position.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, the figures and description provided herein are generally directed to a continuous air flow dehydrator and method of drying grapes into raisins, however, those skilled in the art will readily understand that this is merely for purposes of simplifying the present disclosure and that the present invention is not so limited as it may be utilized for drying other food products into their associated dried food product.

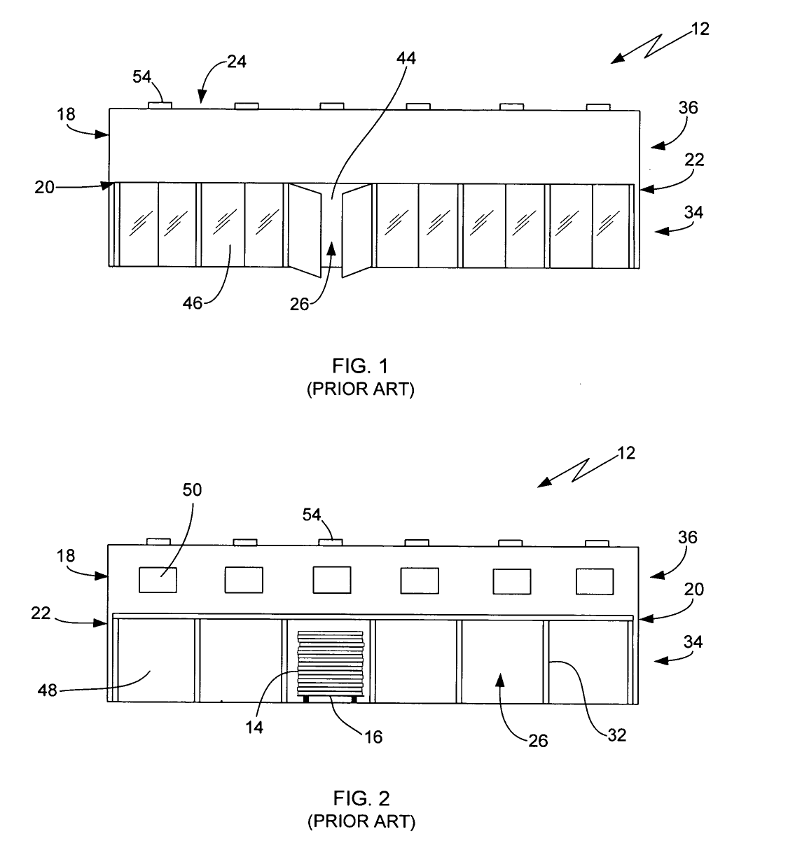

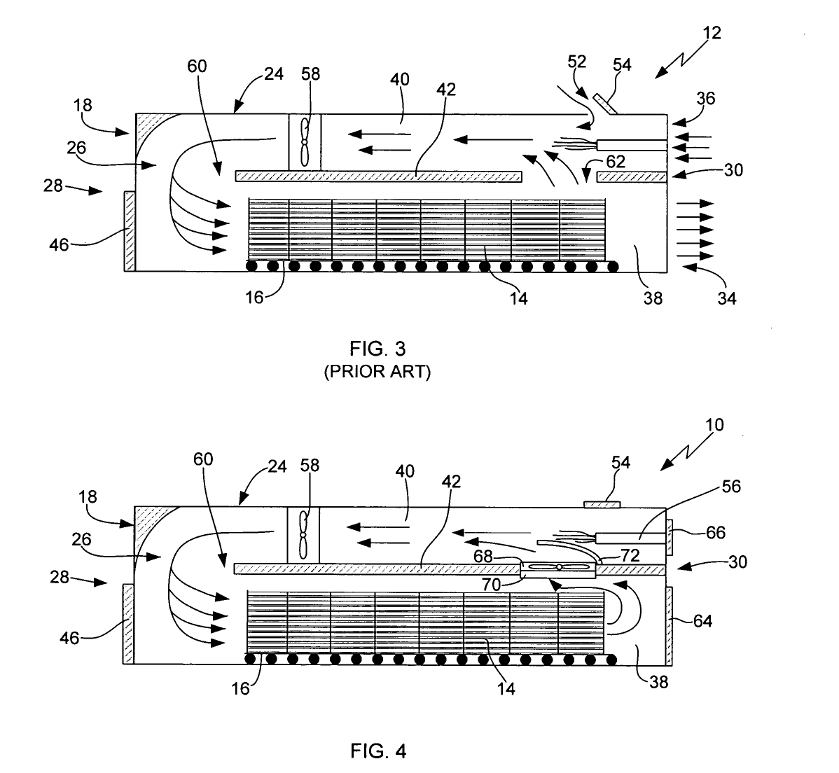

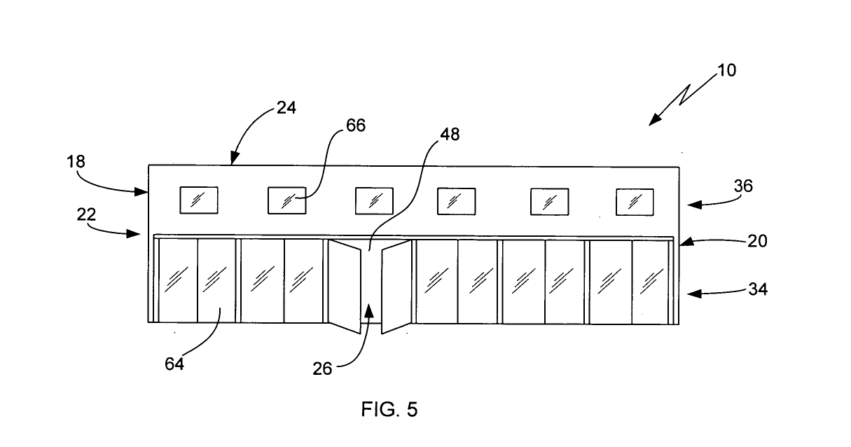

A continuous air flow dehydrator that is manufactured out of the components and configured pursuant to a preferred embodiment of the present invention is shown generally as 10 in the FIGS. 4 and 5. The configuration of an existing commercial air flow dehydrator is shown as 12 in FIGS. 1 through 3. The improved dehydrator 10 of the present invention and the existing dehydrator 12 are utilized to dry raw agricultural food products, such as grapes, into dried food products, such as raisins. The raw food products are placed on trays 14 or other suitable, similarly configured containers that are stacked on top of each and positioned onto a trolley 16 for placement into the dehydrator 12, as shown in FIGS. 2 and 3. As known by those in the industry, instead of trolley 16, the trays 14 may be placed into dehydrator 12 by use of a wheeled cart, chain or belt conveyor systems or other movable or conveying mechanism suitable for moving a stack of trays 14 in and out of dehydrator 12. As best shown in FIG. 3, prior art dehydrator 12 has a dehydrating structure 18 with a first side wall 20, second side wall 22 and top wall 24. In the standard configuration, dehydrating structure 18 defines a plurality of tunnels 26 therein that each have a front or first end 28, a rear or second end 30 and a pair of side walls 32 that separate adjacent tunnels 26, such as the six that are shown in FIG. 1, from each other in such a manner that each tunnel 26 operates independently of the others. Each of the tunnels 26 are divided into a lower level 34 and an upper level 36. As explained in more detail below, lower level 34 defines a drying chamber 38 and upper level 36 defines a burn chamber 40, which are separated inside tunnel 26 by a horizontal dividing wall or floor 42. Dehydrating structure 18 is typically made out of brick, concrete, steel or other appropriate materials, which may be insulated, that are suitable for retaining heat within dehydrating structure 18. Likewise, side walls 32 are made out of materials suitable for retaining heat within the separate tunnels 26 and dividing wall 42 is suitable for separating, except where communication is intended, the burn chamber 40 from the drying chamber 38.

In use, trolley 16 with its stack of trays 14 move into the tunnels 26 on rails or the like, not shown, from the second end 30 and are removed from the tunnels 26 through first end 28 after the food product is dried (i.e., formed into raisins). As shown in FIG. 1, the first end 28 of each tunnel 26 has an front opening 44 that opens into the drying chamber 38 to allow removal of the trays 14 therefrom. While the product is drying inside drying chamber 38, front opening 44 is closed by one or more front drying chamber doors 46, such as the pair of doors 46 for each front opening 44 shown in FIG. 1. The second end 30 of each tunnel 26 has a rear opening 48 that opens into the drying chamber 38 for passage of the trays 14 into the drying chamber 38. Unlike front opening 44, rear opening 48 does not have doors and is not closed in the existing configuration of dehydrator 12. At the upper level 36 of the second end 30 of tunnels 26 is positioned a first vent opening 50 that opens into burn chamber 40. As with rear opening 48, the existing configuration is for first vent opening 50 to be an open area, without any doors or other devices to selectively close vent opening 50. A second vent opening 52, shown in FIG. 3, is typically provided in the top wall 24 so as to open into burn chamber 40. Although trap door 54, shown in FIGS. 2 and 3, is located at second vent opening 52, it is generally left in the open position as shown in FIGS. 1 through 3. First 50 and second 52 vent openings draw in ambient air to burn chamber 40 where, as explained in more detail below, it is heated and then circulated to the drying chamber 38 to dry the food products on trays 14.

Located inside burn chamber 40, typically near the second end 30 of tunnel 16, is a heat source 56 configured to provide the heat necessary to warm the air that is used to dry the food products in the drying chamber 38, as shown in FIG. 3. Typically, heat source 56 is a flame that is fed by propane, natural gas or other gas. As will be understood by those skilled in the art, however, heat source 56 can be other sources of heat, including electric heaters or the like. The fuel for heat source 56 is one of the highest, if not the highest, operating expense for dehydrator 12. Circulating fan 58 draws the heated air from heat source 56 and circulates it to the drying chamber 38. Typically, circulating fan 58 is a thirty-six inch or larger fan capable of providing sufficient force to move the heated air to drying chamber 38 and through trays 14. Circulating fan 58 directs the heated air towards the first end 28 of tunnel 26 where it passes through a forward opening 60 in dividing wall 42 to the drying chamber 38 to dry the food products on trays 14. The closed front drying chamber doors 46 at first end 28 of tunnel 26 prevent any of the heated air from exiting front opening 44 so as to direct the heated air towards the stacks of trays 14. As shown in FIG. 3, the majority of air for heat source 56 and circulating fan 58 is ambient air that is drawn into burn chamber 40 through first vent opening 50 and second vent opening 52 by circulating fan 58, where it is heated by heat source 56 before being forced into drying chamber 38 and through trays 14. After drying the food products on trays 14, the majority of the air exits through rear opening 48 at the second end 30 of tunnel 26. A small percentage of the air circulated by circulating fan 58, estimated at approximately ten percent of the total heated air, is drawn back into burn chamber 40 through rearward opening 62 in dividing wall 42 to mix with the ambient air that is heated by heat source 56.

Although the drying of food products with dehydrator 12 is generally thought to be sufficient with regard to the drying results, the major problem with this current configuration is the amount of fuel necessary to obtain sufficient heat from heat source 56 to warm the circulating air and dry the food products on trays 14. As shown on FIG. 3, much of the heated air is lost to the atmosphere through the rear opening 48 of each of the tunnels 26 and the associated heating of the ambient air drawn in through first 50 and second 52 vent openings. In any dehydrator facility, this is a major expense that can affect the profitability of the final dried food product. With regard to raisins and prunes, the cost of drying the raw grapes and plums is generally borne by the grower, who is often already working on somewhat narrow margins. Substantially reducing the cost of operating dehydrator 12, therefore, will directly and substantially affect the returns received by the grower for his grapes or plums. As described in more detail below, the improved dehydrator 10 of the present invention provides a substantial reduction in fuel costs and, as a result, substantially improves the value of the dried product to the grower. In addition, the dehydrator 10 reduces air pollution from the discharge of the heated air through rear opening 48 at the second end 30 of tunnels 26.

Dehydrator 10, shown in FIGS. 4 and 5, is configured much the same as dehydrator 12 shown in FIGS. 1 through 3. In fact, one of the major benefits of the present invention is that current dehydrators 12 can be relatively easily and quickly retrofitted to include the principles of dehydrator 10. As with dehydrator 12, dehydrator 10 comprises a dehydrating structure 18 that defines one or more tunnels 26, typically a plurality of tunnels 26, having first end 28, second end 30 and side walls 32. The drying chamber 38 of dehydrator 10 is in the lower level 34 and the burn chamber 40 is in the upper level 36, with the heat source 56 and circulating fan 58 as described above. As with dehydrator 12, the forced air from circulating fan 58 hits against the closed first end 28 of upper level 36, passes through forward opening 60 and, due to the closed front drying chamber doors 46 at front opening 44, is directed to and through the food products (i.e., grapes and plums) on the stacks of trays 14.

The improvements to dehydrator 10 basically comprise closing off the drying chamber 38 and burn chamber 40 from the ambient air and providing a mechanism to circulate and filter the air from the drying chamber 38 to the burn chamber 40, as best shown in FIG. 4. This can be accomplished by providing one or more rear drying chamber doors 64 at the second end 30 of each tunnel 26 to close or at least substantially close rear opening 48 to prevent the loss of the heated air from escaping to the atmosphere. The use of selectively openable rear drying chamber doors 64 is preferred so that rear opening 48 can still be utilized for the ingress of trays 14 on trolley 16. In an alternative embodiment, each tunnel 26 only has an opening at one end (i.e., first end 28) for both the ingress and egress of trays 14, with the opposite end (i.e., second end 30) closed without the need for rear drying chamber doors 64. With either rear drying chamber door 64 or a closed second end 30, all of the heated air will be directed upward through rearward opening 62 into burn chamber 40 instead of being lost to the atmosphere. Although the temperature of the heated air from circulating fan 58 will be reduced after passing through the food products on trays 14, it will be warmer than the ambient air, thereby reducing the amount of heat necessary from heat source 56 to warm it to the desired temperature. In addition, the recycling of the warm air from the drying chamber 38 to the burn chamber 40 will avoid the need to have to discharge that air to the atmosphere. In a preferred embodiment, rear drying chamber doors 64, as well as front drying chamber doors 46, will include a seal or sealing mechanism that substantially sealably closes rear opening 48, although an absolute or complete seal may not be necessary, to further improve the recirculation of the heated air.

To further achieve improved energy efficiency, dehydrator 10 includes a first vent closing member 66 to substantially close first vent opening 50 and a second vent closing member, which in the usual configuration will be trap door 54 (but herein also referred to as second vent closing member) to substantially close second vent opening 52. With first 50 and second 52 vent openings closed to prevent ambient air from entering burn chamber 40, heat source 56 will heat the recycled air from drying chamber 38, which will be drawn in by circulating fan 58 and forced back into drying chamber 38, through forward opening 60, to further dry the food products on trays 14. In one embodiment, the second end 30 of upper level 36 is closed (i.e., no first vent opening 30) and top wall 24 does not have second vent opening 32, thereby eliminating the need for first vent closing member 66 or second vent closing member (trap door) 54. In the most common embodiment of dehydrator 10, which will be as a retrofit of existing dehydrator 12, trap door 54 can be placed in its closed position and first vent closing member 66, which can be a door or panel made out of wood, metal or other suitable material or materials, can either fixedly or selectively close first vent opening 50 to achieve the substantially closed burn chamber 40. As set forth below, the ability to selectively open and close first 50 and second 52 vent openings, as opposed to having closed walls or fixedly closed panels, can be useful for the operation of dehydrator 10 of the present invention.

To facilitate the movement of air from drying chamber 38 to burn chamber 40, the preferred embodiment of dehydrator 10 also includes a secondary or recycling fan 68 disposed in rearward opening 62. Recycling fan 68 is configured to draw air from drying chamber 38 and direct it into burn chamber 40, where it is further heated and then drawn into circulating fan 58 for circulating back to drying chamber 38 to dry the food products in trays 14. Recycling fan 68 can be of the same or similar type of fan as used for circulating fan 58 and the rearward opening 62 can be substantially closed off except for recycling fan 68 to better direct the air from drying chamber 38 to burn chamber 40. Various configurations of fans are suitable for use as recycling fan 68. To remove moisture and/or contaminants from the recycled air, the preferred embodiment of dehydrator 10 of the present invention also includes filter 70, shown in FIG. 3. Filter 70 should be configured to allow substantially dry air to pass while filtering out any moisture or contaminants that are absorbed by the air during its passage over and through the food products on racks 14. Preferably, filter 70 is configured to be removable from dehydrator 70 so the user may clean or replace it as necessary to maintain the desired filtering properties. Filter 70 may also be of the type that is cleanable in place and may be part of a more extensive moisture and/or contaminant filtering system. To assist in directing the air flow from recycling fan 68, the preferred embodiment of dehydrator 10 of the present invention also includes a diversion hood 72, shown in FIG. 4. Diversion hood 72 is sized and configured to deflect the air discharged by recycling fan 68 away from directly contacting the flame of heat source 56 and to direct it towards circulating fan 58. If desired, diversion hood 72 can be adjustable to allow the user to regulate how much of the diverted air is directed towards the flame as opposed to the circulating fan 58, where it will be mixed with the heated air. In addition, dehydrator 10 can be configured such that first vent closing member 66 and/or second vent closing member 54 (trap door) have user controllable mechanisms to allow the user to selectively permit ambient air to enter the dehydrator 10 as needed or desired for improved drying performance. During operation, the user could selectively open one or more of the vent openings 50 and 52 to let in ambient temperature air. In addition, the vent openings 50 and 52 and/or rear opening 48 can be fully or partially open at the beginning of the drying process to circulate air through dehydrator 10 and trays 14.

In use, the user will move trays 14 containing the food products into the drying chamber 38 of tunnel 26 by use of the available conveying mechanism, such as trolley 16. The front drying chamber doors 46 are closed to close the first end 28 of tunnel 26, either before or after the trays 14 are placed in drying chamber 38. In a preferred operation, the heat source 56 is ignited and the circulating fan 58 and recycling fan 68 are started while one or more of the rear opening 48, first vent opening 50 and/or second vent opening 52 are open to circulate air through the system before actual drying operations are begun. Once sufficient circulation has taken place, all openings into drying chamber 38 and burn chamber 40 are closed by using, as necessary, rear drying chamber doors 64, first vent closing member 66 and second vent closing member (trap door) 54. The heated air from heat source 56 is allowed to circulate through drying chamber 38 for a sufficient amount of time to dry the food products to their dried state. During the drying operations, the speed of circulating fan 58 and/or recycling fan 68 may need to adjusted to obtain a preferred air movement through drying chamber 38. Once the food products are dried, heat source 56, circulating fan 58 and recycling fan 68 are turned off and the trays 14 are removed from the drying chamber 38 by use of the conveying mechanism (i.e., trolley 16). In a preferred configuration, the front drying chamber doors 46, rear drying chamber doors 64, first vent closing member 66 and second vent closing member (trap door) 54 are configured with a seal or other sealing mechanism to sealably close so as to substantially prevent any ambient air from entering during the drying process. In another embodiment, one or more of the closing mechanisms are configured to allow the user to selectively open and close the associated openings (i.e., front opening 44, rear opening 48, first vent opening 50 and second vent opening 52) as desired to allow ambient air to enter the drying system of dehydrator 10. Use of dehydrator 10 of the present invention will substantially reduce the amount of fuel consumed during the drying of food products in dehydrator 10 compared to the current configuration of dehydrators 12. The reduction in fuel costs will reduce the costs to the grower of drying his or her food products and, therefore, improve the profitability of his or her growing operations. By reducing the heat necessary to warm the air to the desired temperature, the present invention will also reduce the risk of “burning” or over-drying the food products and result in a better dried product. In addition, the dehydrator 10 of the present invention will substantially eliminate the discharge of pollutants to the atmosphere.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A continuous air flow dehydrator for drying food products on one or more trays, said dehydrator comprising:
a dehydrator structure defining at least one tunnel, said tunnel having a lower level, an upper level, a first end and a second end;
a drying chamber in said lower level of said tunnel, said drying chamber having a front opening at said first end of said tunnel, said drying chamber being substantially closed at said second end of said tunnel;
a burn chamber in said upper level of said tunnel, said burn chamber having one or more vent openings in said dehydrator structure, said vent openings in communication with the atmosphere;
a dividing wall in said tunnel separating said drying chamber and said burn chamber, said dividing wall having a forward opening and a rearward opening, each of said forward opening and said rearward opening interconnecting said drying chamber and said burn chamber;
means for conveying said trays into and out of said drying chamber;
a heat source disposed in said burn chamber towards said second end of said tunnel;
a circulating fan disposed in said burn chamber between said heat source and said first end of said tunnel, said circulating fan configured to circulate heated air from said burn chamber to said drying chamber through said forward opening;
one or more front drying chamber doors at said front opening, said front drying chamber doors configured to selectively close said front opening; and
first closing means at each of said one or more vent openings for closing said vent openings so as to substantially close said tunnel from the atmosphere when said front drying chamber doors are closed.

2. The dehydrator according to claim 1, wherein said drying chamber comprises a rear opening at said second end of said tunnel and said dehydrator further comprising a second closing means at said rear opening for closing said rear opening.

3. The dehydrator according to claim 2, wherein said second closing means is one or more rear chamber drying doors.

4. The dehydrator according to claim 2 further comprising a recirculating fan disposed at said rearward opening, said recirculating fan configured to draw air from said drying chamber and discharge air to said burn chamber.

5. The dehydrator according to claim 4 further comprising a filter disposed at said rearward opening, said filter configured to remove moisture and/or contaminants from the air drawn from said drying chamber.

6. The dehydrator according to claim 5 further comprising a diversion hood in said burn chamber at said rearward opening, said diversion hood configured to direct the air from said drying chamber into said burn chamber.

7. The dehydrator according to claim 6, wherein said diversion hood is configured to direct the air from said drying chamber away from said heat source.

8. The dehydrator according to claim 1 further comprising a recirculating fan disposed at said rearward opening, said recirculating fan configured to draw air form said drying chamber and discharge air to said burn chamber.

9. The dehydrator according to claim 8 further comprising a filter disposed at said rearward opening, said filter configured to remove moisture and/or contaminants from the air drawn from said drying chamber.

10. The dehydrator according to claim 9 further comprising a diversion hood in said burn chamber at said rearward opening, said diversion hood configured to direct the air from said drying chamber into said burn chamber.

11. The dehydrator according to claim 1 further comprising a filter disposed at said rearward opening, said filter configured to remove moisture and/or contaminants from the air drawn from said drying chamber.

12. A continuous air flow dehydrator for drying food products on one or more trays, said dehydrator comprising:
a dehydrator structure defining at least one elongated tunnel, said tunnel having a lower level, an upper level, a first end and a second end;
a drying chamber in said lower level of said tunnel, said drying chamber having a front opening at said first end of said tunnel and a rear opening at said second end of said tunnel;
a burn chamber in said upper level of said tunnel, said burn chamber having a first vent opening at said second end of said tunnel and a second vent opening at a top wall of said dehydrator structure, each of said first vent opening and said second vent opening in communication with the atmosphere;
a substantially horizontal dividing wall in said tunnel separating said drying chamber and said burn chamber, said dividing wall having a forward opening and a rearward opening, each of said forward opening and said rearward opening interconnecting said drying chamber and said burn chamber;
means for conveying said trays into and out of said drying chamber;
a heat source in said burn chamber towards said second end of said tunnel;
a circulating fan disposed in said burn chamber between said heat source and said first end of said tunnel, said circulating fan configured to circulate heated air from said burn chamber to said drying chamber through said forward opening;
one or more front drying chamber doors at said front opening, said front drying chamber doors configured to selectively close said front opening;
one or more rear drying chamber doors at said rear opening, said rear drying chamber doors configured to selectively close said rear opening;
a first vent closing member at said first vent opening; and
a second vent closing member at said second vent opening,
wherein when each of said front drying chamber doors, rear drying chamber doors, first vent closing member and said second vent closing member are closed said tunnel is substantially closed off from the atmosphere.

13. The dehydrator according to claim 12 further comprising a recirculating fan disposed at said rearward opening, said recirculating fan configured to draw air from said drying chamber and discharge air to said burn chamber.

14. The dehydrator according to claim 13 further comprising a diversion hood in said burn chamber at said rearward opening, said diversion hood configured to direct the air from said drying chamber into said burn chamber.

15. The dehydrator according to claim 13 further comprising a filter disposed at said rearward opening, said filter configured to remove moisture and/or contaminants from the air drawn from said drying chamber.

16. The dehydrator according to claim 15 further comprising a diversion hood in said burn chamber at said rearward opening, said diversion hood configured to direct the air from said drying chamber into said burn chamber.

17. The dehydrator according to claim 12 further comprising a filter disposed at said rearward opening, said filter configured to remove moisture and/or contaminants from the air drawn from said drying chamber.

18. A method for drying food products on one or more trays in a continuous air flow dehydrator having a dehydrator structure defining a least one tunnel with a first level, a second level, a first end and a second end, said first level defining a drying chamber and said second level defining a burn chamber, said dehydrator structure having one or more vent openings communicating said burn chamber with the atmosphere, said method comprising the steps of:
a. conveying said trays into a drying chamber in said first level of said tunnel, said drying chamber having a front opening at a first end of said tunnel and a rear opening at a second end of said tunnel;
b. closing said front opening with one or more front drying chamber doors before, during or after said conveying step;
c. closing each of said vent openings with a vent closing member before, during or after said conveying step;
d. closing said rear opening with one or more rear drying chamber doors;
e. heating the air in said burn chamber with a heat source disposed in said burn chamber;
f. circulating the air from said burn chamber to said drying chamber through a forward opening in a dividing wall separating said burn chamber from said drying chamber with a circulating fan disposed between said heat source and said first end of said tunnel; and
g. circulating the air from said drying chamber into said burn chamber through a rearward opening in said dividing wall with a recycling fan disposed at said rearward opening.

19. The method of claim 18, wherein one or more of said closing steps are accomplished after said heating step and after each of said air circulating steps.

20. The method of claim 18, wherein said dehydrator further comprises a filter disposed at said rearward opening, said filter configured to remove moisture and/or contaminants from the air drawn from said drying chamber.
